(19) United States
(12) Patent Application Publication
(10) Pub. No.: US 2024/0424699 A1
(43) Pub. Date: Dec. 26, 2024

(54) Hair Clipper Leveling Device

(71) Applicant: Albert Sheffey, Taylor, TX (US)

(72) Inventor: Albert Sheffey, Taylor, TX (US)

(21) Appl. No.: 18/212,246

(22) Filed: Jun. 21, 2023

(51) Int. Cl. B26B 19/38

(52) U.S. Cl. CPC B26B 19/382; B26B 19/3853; B26B 19/388

(57) ABSTRACT

A hair clipper leveling device for precisely trimming lines into a person's hair includes a clipper which includes a handle and a trimming head movably attached to the handle to trim hair when the handle is gripped. A level unit is integrated into the handle of the clipper and the level unit is oriented to measure deflection of the clipper along a lengthwise axis of the clipper. In this way the level unit facilitates a user to trim precisely measured lines in the hair. The level unit includes a display which displays indicia comprising numbers to indicate a degree of deflection from the lengthwise axis.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hair clipper devices and more particularly pertains to a new hair clipper device for precisely trimming lines into a person's hair. The device includes a clipper that has a trimming head and a level unit that is attached to the clipper. The level unit includes a display for displaying indicia to indicate a degree of deflection of the clipper from a vertical axis. In this way the clipper can be oriented at a precise angle for trimming lines into the person's hair.

### (2) Description of Related Art Including Information Disclosed Under 37 CFR 1.97 and 1.98

The prior art relates to hair clipper devices including a variety of hair trimming devices that has either a plurality of light emitters for indicating a deflection of a hair trimming device from a vertical axis or a bubble level for indicating deflection of a hair trimming device from a vertical axis. In no instance does the prior art disclose a hair clipper and a display attached to the clipper which displays numbers to indicate a degree of deflection from a vertical axis.

### BRIEF SUMMARY OF THE INVENTION

An embodiment of the disclosure meets the needs presented above by generally comprising a clipper which includes a handle and a trimming head movably attached to the handle to trim hair when the handle is gripped. A level unit is integrated into the handle of the clipper and the level unit is oriented to measure deflection of the clipper along a lengthwise axis of the clipper. In this way the level unit facilitates a user to trim precisely measured lines in the hair. The level unit includes a display which displays indicia comprising numbers to indicate a degree of deflection from the lengthwise axis.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an embodiment of the disclosure.

FIG. 2 is a bottom perspective view of a hair clipper leveling device according to an embodiment of the disclosure.

FIG. 3 is a right side phantom view of an embodiment of the disclosure.

FIG. 4 is a bottom view of an embodiment of the disclosure.

FIG. 5 is a bottom view of an embodiment of the disclosure showing a clipper being deflected from a vertical axis.

FIG. 6 is a perspective in-use view of an embodiment of the disclosure.

FIG. 7 is a perspective view of an alternative embodiment of the disclosure.

### DETAILED DESCRIPTION OF THE INVENTION

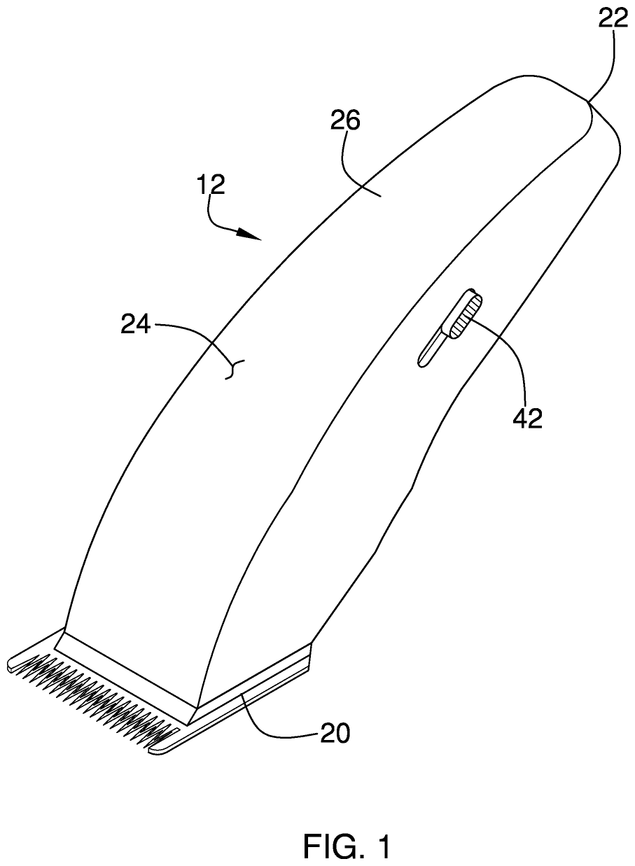

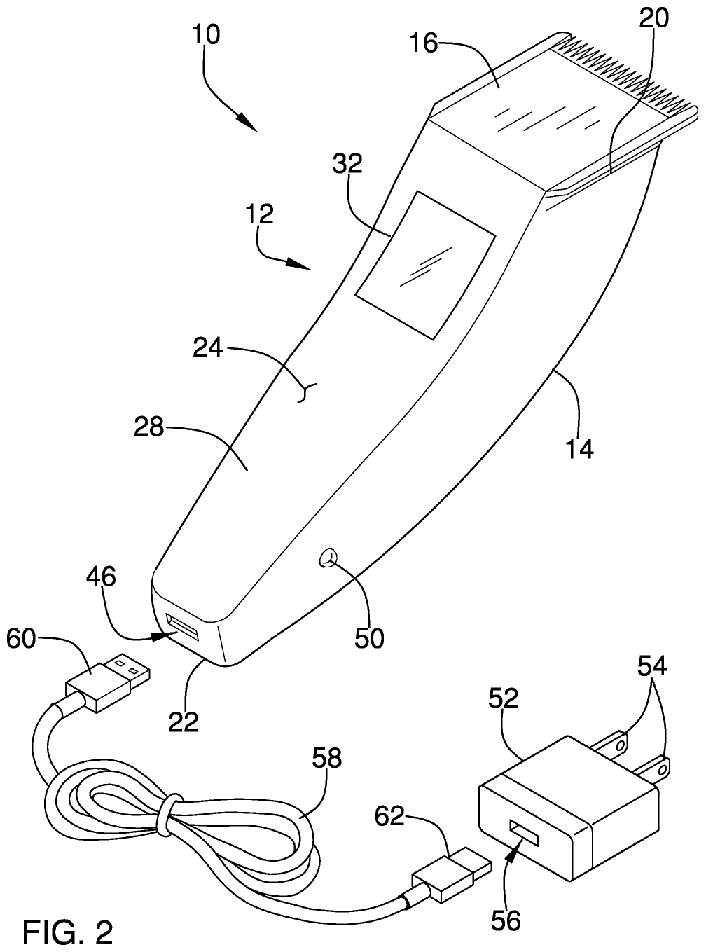

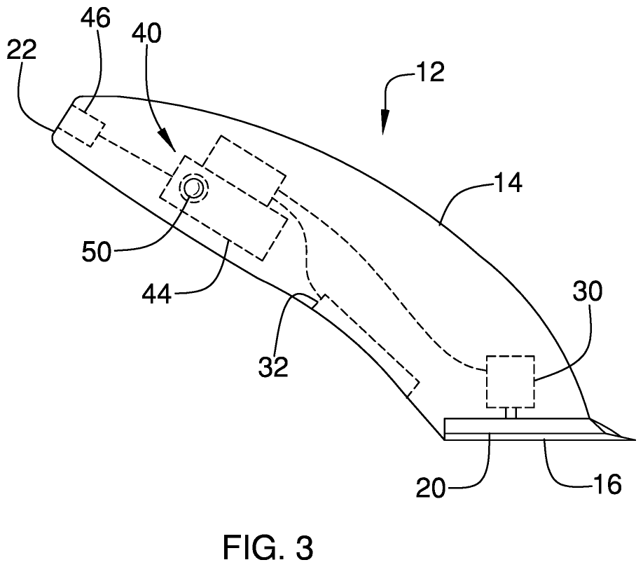

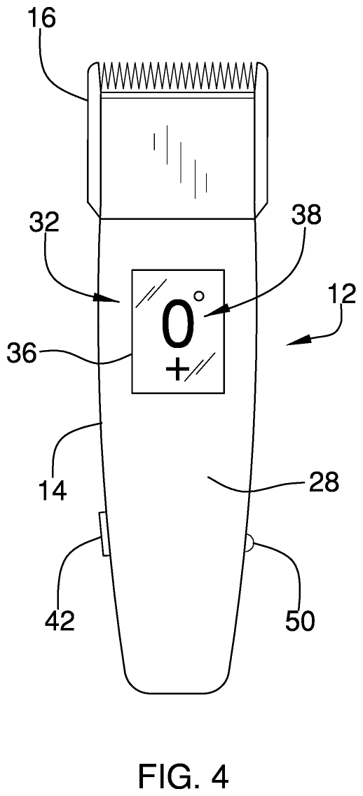

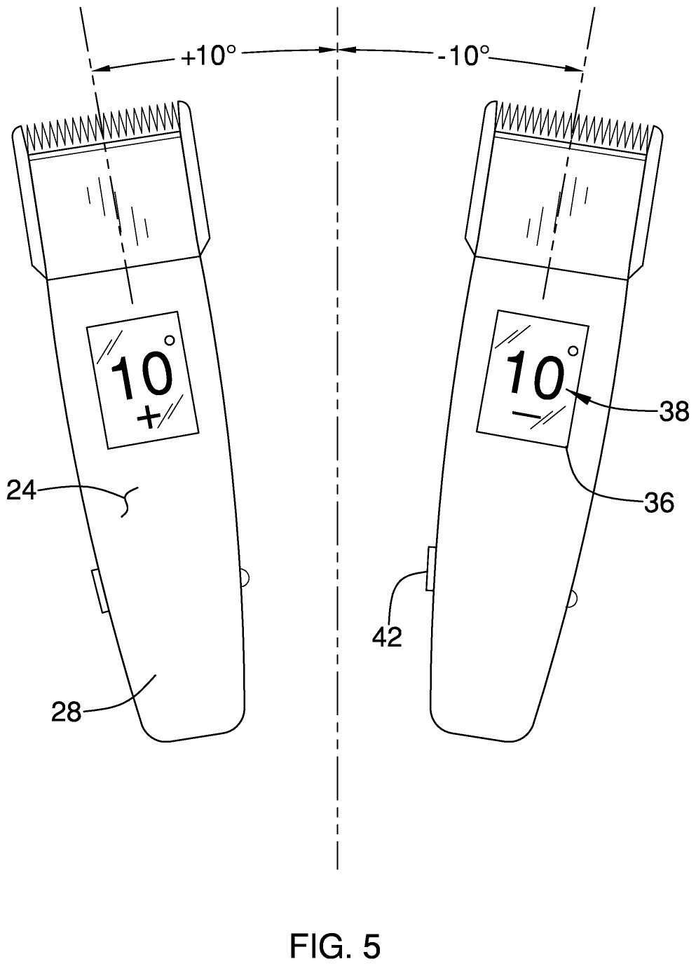

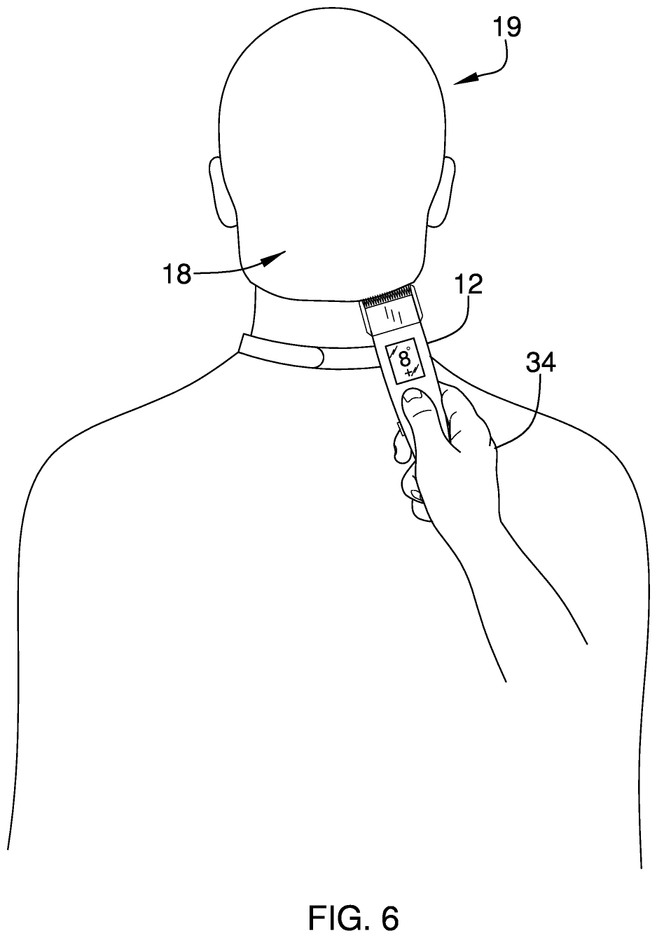

With reference now to the drawings, and in particular to FIGS. 1 through 7 thereof, a new hair clipper device embodying the principles and concepts of an embodiment of the disclosure and generally designated by the reference numeral 10 will be described.

As best illustrated in FIGS. 1 through 7, the hair clipper leveling device 10 generally comprises a clipper 12 which includes a handle 14 and a trimming head 16 that is movably attached to the handle 14. The trimming head 16 can be oriented to trim hair 18 on a person 19 when the handle 14 is gripped. The handle 14 has a first end 20, a second end 22 and an outer surface 24 extending between the first end 20 and the second end 22; the handle 14 is elongated between the first end 20 and the second end 22 and the trimming head 16 is positioned on the first end 20. The outer surface 24 has a top side 26 and a bottom side 28 and each of the top side 26 and the bottom side 28 curves upwardly between the first end 20 and the second end 22. The clipper 12 includes a motor 30 that is positioned within the handle 14 and the motor 30 is in mechanical communication with the trimming head 16 for driving the trimming head 16. The motor 30 may comprise an electric motor or the like and the trimming head 16 may include a stationary blade and a sliding blade that is driven by the motor 30.

A level unit 32 is provided and the level unit 32 is integrated into the handle 14 of the clipper 12. The level unit 32 is oriented to measure deflection of the clipper 12 along a lengthwise axis of the clipper 12 to facilitate a user 34 to trim precisely measured lines in the hair 18. In this way the user 34 can cut elaborate ornamental shapes in the person's hair 18. The user 34 may be a barber, for example, and the person 19 may be a patron in a barber shop. The level unit 32 includes a display 36 which displays indicia 38 comprising numbers to indicate a degree of deflection from the lengthwise axis and a plus or minus sign to indicate deflection to the left of the lengthwise axis or deflection to the right of the lengthwise axis.

The lengthwise axis extends through the first end 20 and the second end 22 of the handle 14. The trimming head 16 is oriented to cut along a line that is perpendicularly oriented with the lengthwise axis of the clipper 12. In this way the trimming head 16 facilitates the user 34 to precisely trim a line which is deflected from a horizontal axis. The display 36 is integrated into the bottom side 28 of the outer surface 24 of the handle 14 and the display 36 may comprise a liquid crystal display or other type of electronic display.

A power supply 40 is integrated into the clipper 12 and the power supply 40 is electrically coupled to the motor 30. The power supply 40 comprises a power switch 42 that is slidably integrated into the outer surface 24 of the handle 14 of the clipper 12. The power switch 42 is electrically coupled to the motor 30 and the power switch 42 is positionable between an on position and an off position for actuating and de-actuating the motor 30. The power supply 40 includes a rechargeable battery 44 that is integrated into the handle 14 and the rechargeable battery 44 is electrically coupled to the motor 30.

The power supply 40 includes a charge port 46 that is recessed into the second end 22 of the handle 14 and the charge port 46 is electrically coupled to the rechargeable battery 44 for charging the rechargeable battery 44. Additionally, the charge port 46 may comprise a universal serial bus port or other type of female charging port. The power supply 40 includes an indicator 50 that is attached to the outer surface 24 of the handle 14 such that the indicator 50 is visible to the user 34. The indicator 50 is electrically coupled to the rechargeable battery 44 and the indicator 50 emits a visual alert which changes color corresponding to a charge level of the rechargeable battery 44. In this way the indicator 50 facilitates the user 34 to visually identify the charge level of the rechargeable battery 44. The indicator 50 may comprise a light emitter or other type of electronic visual alert.

The power supply 40 includes a charger 52 that has a male plug 54 for plugging into a female electrical outlet and the charger 52 includes an output port 56. The power supply 40 includes a charge cord 58 that has a first plug 60 and a second plug 62. The first plug 60 is matable to the output port 56 in the charger 52 and the second plug 62 is matable to the charge port 46 in the handle 14 of the clipper 12. The charge port 46 in the handle 14 may comprise a universal serial bus port or the like and the second plug 62 may comprise a universal serial bus port plug. The output port 56 in the charger 52 may comprise a miniature universal serial bus port or the like and the first plug 60 may comprise a miniature universal serial bus plug or the like.

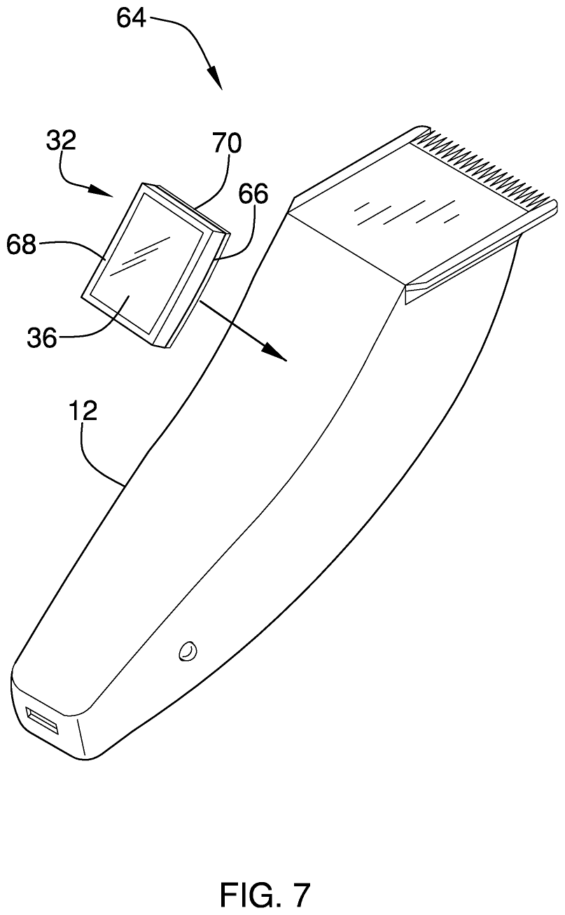

In an alternative embodiment 64 shown in FIG. 7, the level unit 32 has a rear wall 66 and a front wall 68 and the display 36 is integrated into the front wall 68. The level unit 32 includes an adhesive layer 70 that is applied to the rear wall. Additionally, the level unit 32 is positionable on the bottom side 28 of the outer surface 24 of the handle 14 such that the adhesive layer adheres to the bottom side 28 for attaching the level unit 32 to the handle 14. In this way the level unit 32 can be retrofitted onto any existing clipper 12 for enhance the performance of the existing clipper 12.

In use, the clipper 12 is held such that the display 36 is visible to the user 34. In this way the user 34 can read the display 36 in order to hold the clipper 12 at a precise angle. Thus, the user 34 can precisely trim transition lines and other types of lines that are commonly cut into hair 18. In this way the user 34 can complete complex and ornamental haircuts with a level of precision that would otherwise be impossible thereby facilitating the person 19 getting the haircut to enjoy the highest level of quality and appearance in their haircut. Furthermore, the rechargeable battery 44 in the clipper 12 facilitates the clipper 12 to be oriented in a variety of orientations without being impeded by a power cord.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hair clipper leveling device for precisely trimming lines in a person's hair, said device comprising:
a clipper including a handle and a trimming head movably attached to said handle wherein said trimming head is configured to trim hair when said handle is gripped; and
a level unit being integrated into said handle of said clipper, said level unit being oriented to measure deflection of said clipper along a lengthwise axis of said clipper wherein said level unit is configured to facilitate a user to trim precisely measured lines in the hair, said level unit including a display which displays indicia comprising numbers to indicate a degree of deflection from said lengthwise axis.

2. The device according to claim 1, wherein:
said handle has a first end, a second end and an outer surface extending between said first end and said second end, said handle being elongated between said first end and said second end;
said trimming head is positioned on said first end;
said outer surface has a top side and a bottom side, each of said top side and said bottom side curving upwardly between said first end and said second end; and
said lengthwise axis extends through said first end and said second end of said handle.

3. The device according to claim 2, wherein said display is integrated into said bottom side of said outer surface of said handle.

4. The device according to claim 2, wherein said trimming head is oriented to cut along a line being perpendicularly oriented with said lengthwise axis of said clipper wherein said trimming head is configured to facilitate the user to precisely trim a line which is deflected from a horizontal axis.

5. The device according to claim 1, wherein:
said handle has a first end, a second end and an outer surface extending between said first end and said second end;
said clipper includes a motor being positioned within said handle, said motor being in mechanical communication with said trimming head for driving said trimming head; and
said device includes a power supply being integrated into said clipper, said power supply being electrically coupled to said motor, said power supply comprising:
a power switch being slidably integrated into said outer surface of said handle of said clipper, said power switch being electrically coupled to said motor, said power switch being positionable between an on position and an off position for actuating and de-actuating said motor;
a rechargeable battery being integrated into said handle, said rechargeable battery being electrically coupled to said motor;
a charge port being recessed into said second end of said handle thereby facilitating said charge port to insertably receive a charge cord, said charge port being electrically coupled to said rechargeable battery for charging said rechargeable battery; and
an indicator being attached to said outer surface of said handle wherein said indicator is configured to be visible to the user, said indicator being electrically coupled to said rechargeable battery, said indicator emitting a visual alert which changes color corresponding to a charge level of said rechargeable battery wherein said indicator is configured to facilitate the user to visually identify the charge level of said rechargeable battery.

6. A hair clipper leveling device for precisely trimming lines in a person's hair, said device comprising:
a clipper including a handle and a trimming head movably attached to said handle wherein said trimming head is configured to trim hair when said handle is gripped, said handle having a first end, a second end and an outer surface extending between said first end and said second end, said handle being elongated between said first end and said second end, said trimming head being positioned on said first end, said outer surface having a top side and a bottom side, each of said top side and said bottom side curving upwardly between said first end and said second end, said clipper including a motor being positioned within said handle, said motor being in mechanical communication with said trimming head for driving said trimming head;
a level unit being integrated into said handle of said clipper, said level unit being oriented to measure deflection of said clipper along a lengthwise axis of said clipper wherein said level unit is configured to facilitate a user to trim precisely measured lines in the hair, said level unit including a display which displays indicia comprising numbers to indicate a degree of deflection from said lengthwise axis, said display being integrated into said bottom side of said outer surface of said handle, said lengthwise axis extending through said first end and said second end of said handle, said trimming head being oriented to cut along a line being perpendicularly oriented with said lengthwise axis of said clipper wherein said trimming head is configured to facilitate the user to precisely trim a line which is deflected from a horizontal axis; and
a power supply being integrated into said clipper, said power supply being electrically coupled to said motor, said power supply comprising:
a power switch being slidably integrated into said outer surface of said handle of said clipper, said power switch being electrically coupled to said motor, said power switch being positionable between an on position and an off position for actuating and de-actuating said motor;
a rechargeable battery being integrated into said handle, said rechargeable battery being electrically coupled to said motor;
a charge port being recessed into said second end of said handle thereby facilitating said charge port to insertably receive a charge cord, said charge port being electrically coupled to said rechargeable battery for charging said rechargeable battery; and
an indicator being attached to said outer surface of said handle wherein said indicator is configured to be visible to the user, said indicator being electrically coupled to said rechargeable battery, said indicator emitting a visual alert which changes color corresponding to a charge level of said rechargeable battery wherein said indicator is configured to facilitate the user to visually identify the charge level of said rechargeable battery.

7. The device according to claim 6, wherein said level unit has a rear wall and a front wall, said display being integrated into said front wall, said level unit including an adhesive layer being applied to said rear wall, said level unit being positionable on said bottom side of said outer surface of said handle such that said adhesive layer adheres to said bottom side for attaching said level unit to said handle.
